(19) United States
(12) Patent Application Publication
(10) Pub. No.: US 2003/0041630 A1
(43) Pub. Date: Mar. 6, 2003

(54) Rekeyable lock with circumferential pin configuration

(76) Inventors: Daniel A. Laitala, Bloomington, MN (US); Grant T. Laitala, Phoenix, AZ (US); Thomas R. Laitala, Plymouth, MN (US)

Correspondence Address: MERCHANT & GOULD PC, P.O. BOX 2903, MINNEAPOLIS, MN, 55402-0903, US

(21) Appl. No.: 09/945,382

(22) Filed: Aug. 31, 2001

(51) Int. Cl. E05B 67/24

(52) U.S. Cl. 70/38 A

(57) ABSTRACT

This disclosure relates to a rekeyable tubular lock cylinder with a core. The core includes a first core piece having locking pin openings and a second core piece having replaceable pin openings. An outer sleeve is mounted over the first and second core pieces. The outer sleeve includes a sleeve end face defining a circular opening coaxially aligned with a hub portion of the second core piece. The sleeve end face and the hub portion cooperate to define an annular keyway. The second core piece is rotatable between a first position where the key receiving notch of the hub portion aligns with a first outer notch of the outer sleeve, and a second position where the key receiving notch of the hub portion aligns with the second outer notch. The replaceable pin openings of the second core piece are aligned with the locking pin openings of the first core piece when the hub portion of the second core piece is in the first position, and the replaceable pin openings of the second core piece are not aligned with the locking pin openings of the first core piece when the hub is in the second position.

### FIELD OF THE INVENTION

The present invention relates to rekeyable locks, more particularly the present invention relates to rekeyable locks utilizing tubular keys.

### BACKGROUND OF THE INVENTION

A tubular lock core is a lock core actuated by a cylindrical form key. In tubular locks the locking pins are arranged in a circumferential configuration. These tubular lock cores can be incorporated into a variety of different locks to actuate the release mechanism, including but not limited to padlocks, vending machine locks, and automobile and motorcycle ignition switches. It is desirable to be able to rekey these locks for security and convenience reasons. For security, rekeying such a lock is desirable if there is concern regarding the current key being lost or stolen. For convenience, it is desirable to be able to rekey two different locks to accept the same key and thereby reduce the number of unique keys required.

### SUMMARY OF THE INVENTION

The present invention relates to a tubular lock having structure for facilitating re-keying the lock.

### BRIEF DESCRIPTION OF THE DRAWINGS

The accompanying drawings, which are incorporated in and constitute a part of the description, illustrate several aspects of the invention and together with the description, serve to explain the principles of the invention. A brief description of the drawings is as follows:

FIG. 1 is a perspective view of the major components of one embodiment of a lock in accordance with the invention.

FIG. 2 is a partial cross-section view of the lock of FIG. 1 with the shackle closed and locked.

FIG. 3 is a partial cross-section view of the lock of FIG. 1 with the shackle open.

FIG. 4 is the lock of FIG. 3 with the tubular cylinder core removed.

FIG. 5 is an exploded view of the tubular cylinder core of FIG. 4 with one locking pin spring, one locking pin and one replaceable pin shown.

FIG. 6 is an end view of the outer sleeve of the tubular cylinder core of FIG. 5 in an operational position.

FIG. 7 is an end view of the outer sleeve of the tubular cylinder core of FIG. 5 in the rekeying position.

FIG. 8 is a perspective view of a tubular key for use with a tubular cylinder core of FIG. 5.

FIG. 9 is an end view of the assembled tubular lock cylinder of FIG. 5 showing the motion limiter plate and index pin.

FIG. 10 is a cross-sectional view of the tubular cylinder core of FIG. 5 taken through the circumferentially spaced-apart pin openings, the locking pin openings and the replaceable pin openings are shown aligned and the locking pins are shown crossing the shear plane, the core has been “laid flat” or “rolled put” such that a circumference defined by the pin openings is depicted as a length of the core.

FIG. 11 is a cross-sectional view of the tubular cylinder core of FIG. 9, with the locking pins aligned with the shear plane.

FIG. 12 is a cross-sectional view of the tubular cylinder core of FIG. 10, with the replaceable pins openings not aligned with the locking pin openings and the replaceable pins removed.

### DETAILED DESCRIPTION

The rekeyable tubular lock cylinder in accordance with the present invention is designed to be utilized with a variety of lock bodies and permit users of tubular key locks to quickly and easily rekey the locks to work with new keys for security and/or convenience reasons. Examples of applications for the invention are rekeying multiple locks in the field with a minimum of tools and parts, and low worker skill requirements, and rekeying padlocks to use the same tubular key as other locks or machinery ignition switches, permitting fewer keys to be carried.

Reference will now be made in detail to exemplary aspects of the present invention which are illustrated in the accompanying drawings. Wherever possible, the same reference numbers will be used throughout the drawings to refer to the same or like parts.

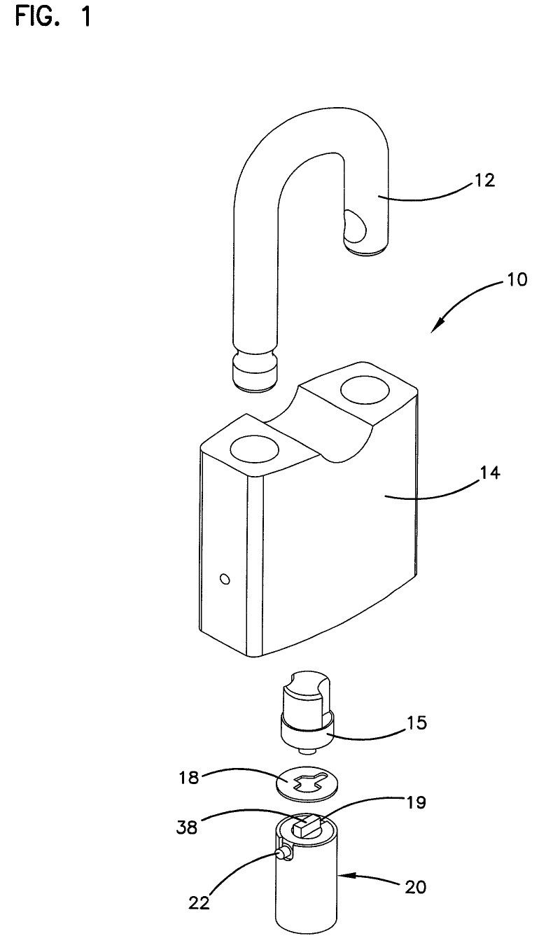

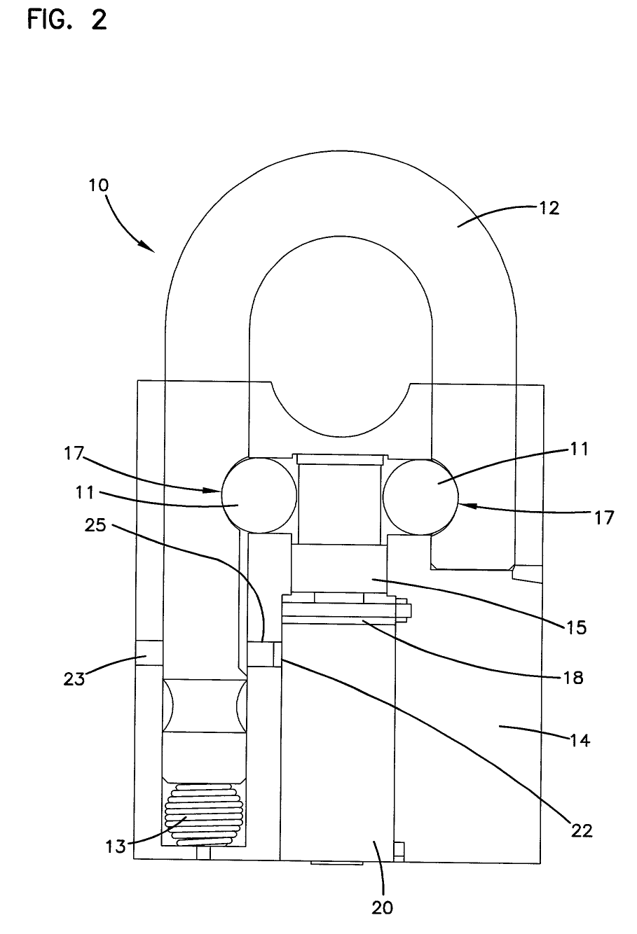

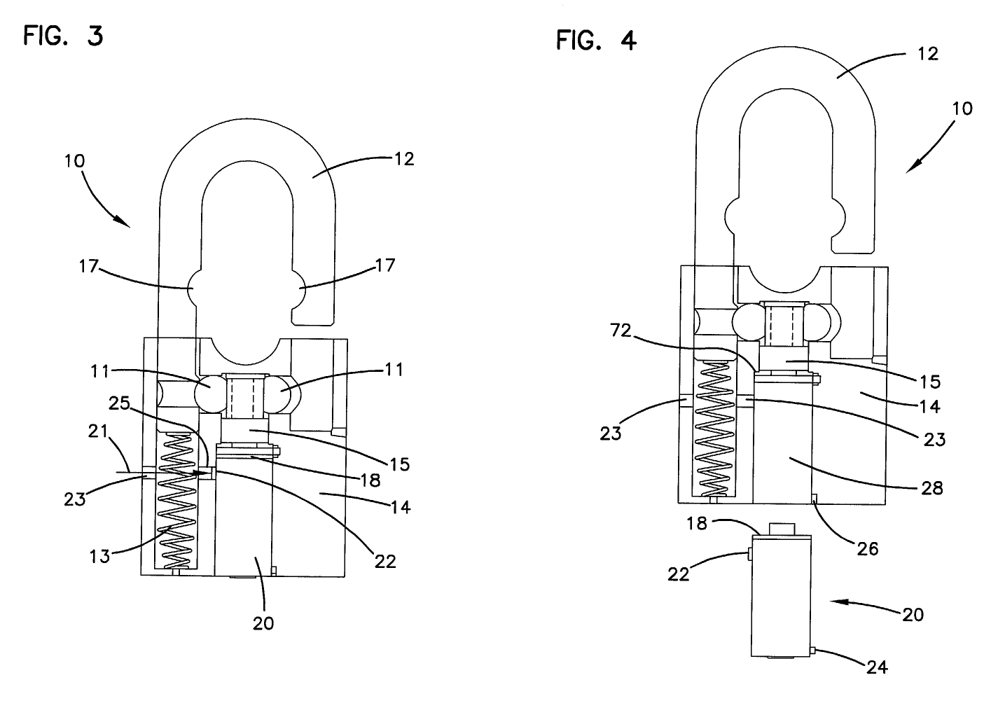

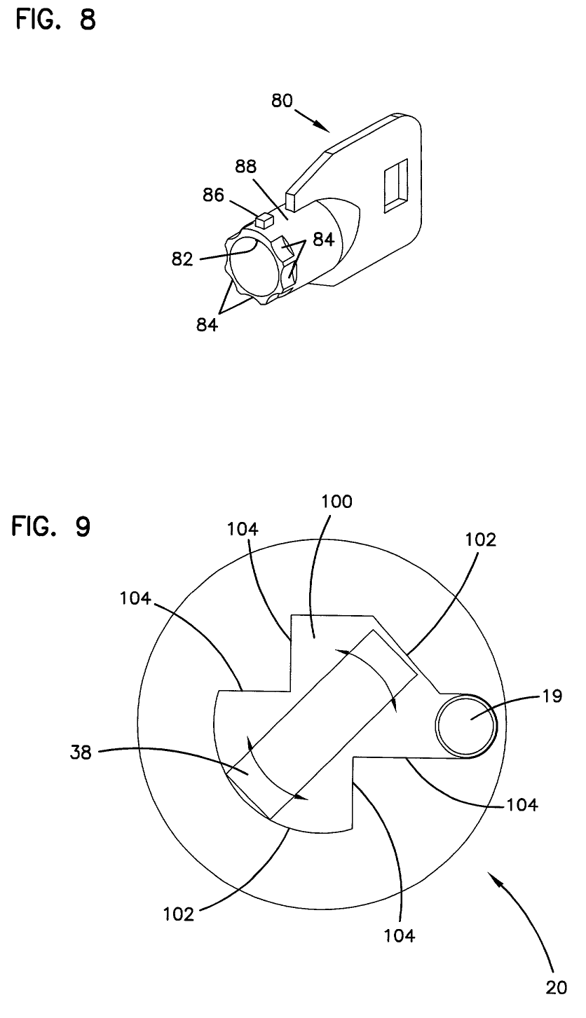

Referring to FIGS. 1 through 3, an embodiment of the invention is shown as a rekeyable padlock 10. Padlock 10 includes a shackle 12 and a lock body 14. Within lock body 14 is a lock release 15 and locking balls 11. Lock release 15 is movable between a first position where balls 11 engage locking recesses 17 of shackle 12 and hold shackle 12 closed, shown in FIG. 2, and a second position where balls 11 are allowed to move, releasing shackle 12 and allowing a shackle spring 13 to push shackle 12 open, shown in FIG. 3. A rekeyable tubular cylinder 20 is mounted within lock body 14. Cylinder 20 is adapted to receive a tubular key as shown in FIG. 8. By turning the key within cylinder 20, the lock release 15 is moved between the first and second positions. A motion limiter plate 18 is located between rekeyable tubular cylinder 20 and lock release 15 for limiting the rotational movement of the cylinder to a predetermined range. Plate 18 is described in further detail below.

Referring to FIG. 3, rekeyable padlock 10 is shown with rekeyable tubular cylinder 20 in place and engaging lock release 15. Cylinder 20 is held within lock body 14 by a cylinder release mechanism 22, (e.g., a spring loaded pin). Release mechanism 22 fits within an opening 25 defined by the lock body 14 to prevent cylinder 20 from being pulled from lock body 14. To remove cylinder 20 from lock body 14, release mechanism is pushed inwardly until fully recessed within cylinder 20. Arrow 21 shows the direction of force applied by an appropriately shaped tool through an opening 23 in lock body 14 to cylinder release mechanism 22 to permit rekeyable tubular cylinder 20 to be removed from lock body 14. When shackle 12 is locked, shackle 12 blocks opening 23, thereby preventing the cylinder from being removed from lock body 14.

FIG. 4 shows rekeyable padlock 10 with rekeyable tubular cylinder 20 removed from lock body 14. Also shown are index pin 24 protruding from the lower edge of tubular cylinder core 20 and a corresponding index slot 26 in the sidewall base of core receiving opening 28. Index pin 24 fits in slot 26 to ensure that the cylinder 20 is mounted at a particular rotational orientation within opening 28.

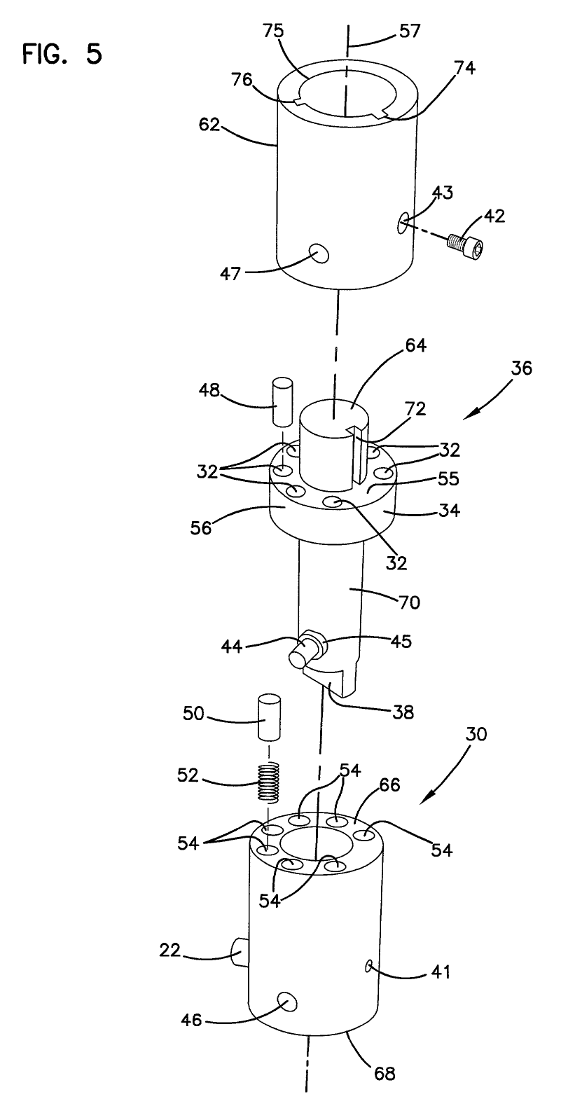

FIG. 5 shows the elements of tubular cylinder core 28 in isolation of lock body 14. Tubular cylinder core 20 is composed of several major components, including an outer sleeve 62, a first core piece 30, and a second core piece 36. First core piece 30 defines one or more axial locking pin openings 54, spaced circumferentially (i.e., in a circle about a reference axis 57) about first core piece 30 and extending from a front end face 66 at least partially through first core piece 30 toward a rear end face 68. A motion limiter index pin 19 (shown in FIG. 9) protrudes from rear end face 68. Locking pins 50 and locking pin springs 52 are mounted in the locking pin openings 54.

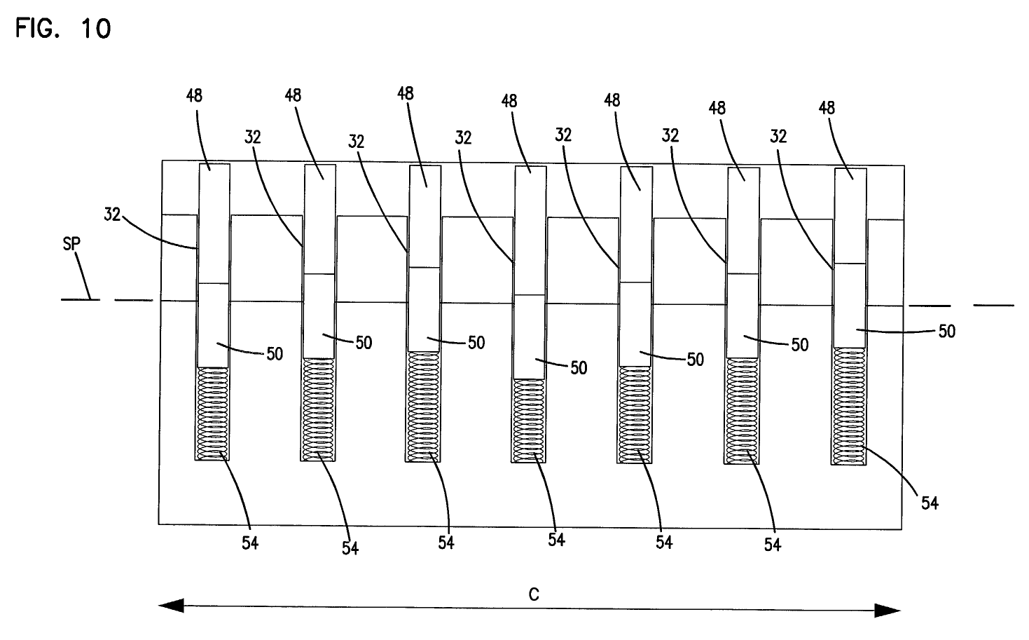

Still referring to FIG. 5, second core piece 36 includes a hub portion 64, a cylinder portion 34, an intermediate shaft portion 70, and a lock release engaging portion 38. Cylinder portion 34 defines one or more replaceable pin openings 32 extending axially through hub portion 34. Openings 32 extend completely through hub portion 34 from a front face 55 to a rear face 56. When core 20 is assembled, rear face 56 of second core piece 36 opposes front face 66 of first core piece 30 such that a shear plane SP is defined (see FIGS. 10 through 12). Replaceable pins 48 are mounted within the replaceable pin openings 32.

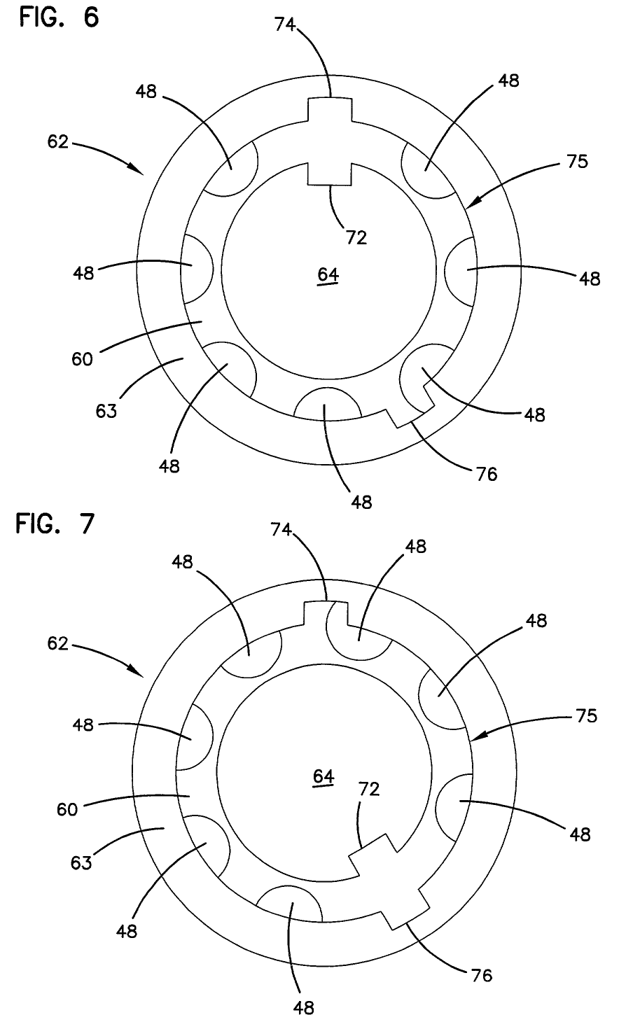

Outer sleeve 62 of core 20 defines a hub receiving opening 75, and, in cooperation with hub portion 64 of second core piece 36, defines an annular keyway 60 (shown in FIG. 6), shaped to receive standard tubular keys. Note that replaceable pins 48 and locking pins 50 are the same longitudinal shape and diameter, and that replaceable pin openings 32 and locking pin openings 54 are sized to slidably receive replaceable pins 48 and locking pins 50.

FIGS. 6 and 7 show the key receiving end of outer sleeve 62. When assembled as part of tubular cylinder core 20, hub portion 64 of second core piece 36 extends into the opening 75 to form the annular keyway 60. Opening 75 is defined by a rim 63 of sleeve 62. A first index notch 74 and a second index notch 76 are formed in rim 63 of outer sleeve 62. As shown in FIG. 6, rim 63 also functions to hold replaceable pins 48 within hub portion 64 of second core piece 36.

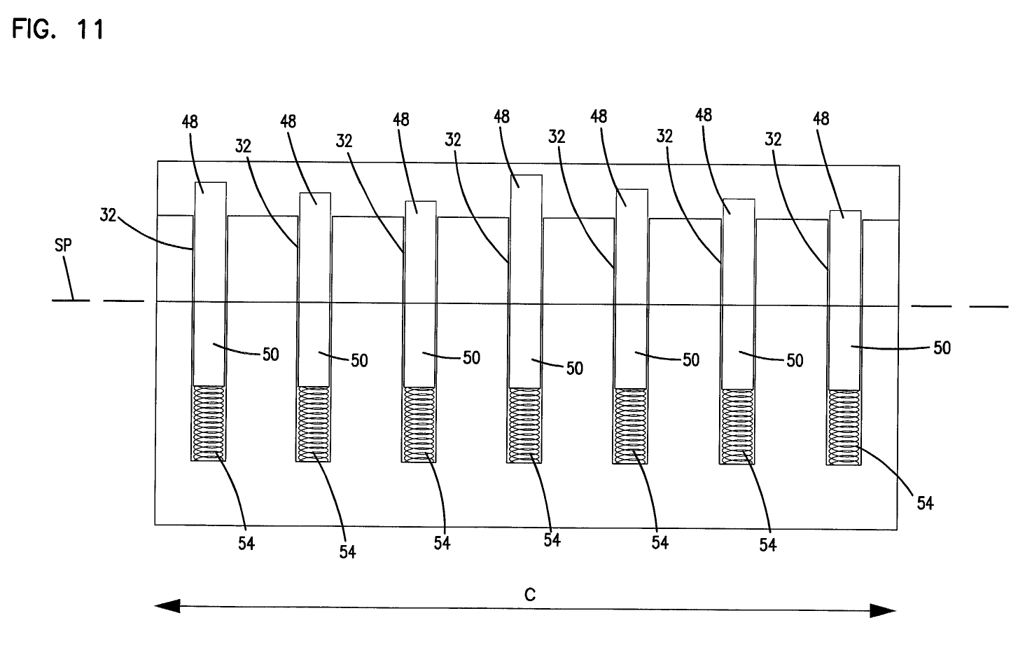

FIG. 8 shows a tubular key 80 for use with lock 10. Key 80 includes recessed flats 84 spaced about the circumference of key 80. When a key 80 is inserted in annular keyway 60, flats 84 of key 80 depress replaceable pins 48 in replaceable pin openings 32, which in turn depress locking pins 50 into locking pin openings 54, compressing locking pin springs 52. Key 80 includes a hub interface tab 82 and an index tab 86. Hub interface tab 82 is received by slot 72 in hub portion 64 of second core piece 36. Hub interface tab 82 and slot 72 combine to allow rotational torque to be applied by key 80 to second core piece 36. Hub interface tab 82 and slot 72 also cooperate to ensure that key 80 is inserted into annular keyway 60 so that pin engaging flats 84 are appropriately aligned to engage replaceable pins 48. Index tab 86 of key 80 cooperates with index notches 74 and 76 of outer sleeve 62 to only allow key 80 to be inserted or removed from annular keyway 60 when second core piece 36 is turned to either the operational or rekeying positions. The operational position, shown in FIG. 6, corresponds to index notch 74 and the rekeying position, shown in FIG. 7, corresponds to index notch 76. When a key 80 with appropriately configured pin engaging flats 84 is inserted into annular keyway 60, replaceable pins 48 and locking pins 50 are depressed into openings 32 and 54, respectively, until pin interfaces 58 align with the shear plane created by rear face 56 of cylinder portion 34 of second core piece 36 and front end face 66 of first core piece 30 (see FIG. 11). When pin interfaces 58 are aligned with this shear plane, the second core piece 36 can be rotated with respect to the rest of tubular core 20 by applying torque using key 80, hub interface tab 82 and slot 72.

Referring now to FIG. 9, a hole 100 of motion limiter plate 18 interfaces with motion limiter index pin 19 to constrain the range of motion of lock release engaging portion 38. The range of motion of lock release engaging portion 38 is limited to that required to rotatably actuate lock release 15, and will not allow second core piece 36 to be rotated to the rekeying position, which will be described below. Hole 100 in motion limiter plate 18 receives lock release engaging portion 38 and motion limiter index pin 19. Motion limiter pin 19 prevents motion limiter plate 18 from rotating relative to first core piece 30. Arcuate slots 102 in hole 100 allow a limited range of motion of second core piece 36 relative to first core piece 30. Edge stops 104 constrain the range of motion of lock release engaging portion 38.

In normal lock usage, a key can only be inserted into and removed from keyway 60 when second core piece 36 is in the operational position. In normal lock usage, motion limiter plate 18 is held in position engaging motion limiter index pin 19 and lock release engaging portion 38 by a shoulder 72 (see FIG. 4) in tubular cylinder receiving opening 28. When rekeyable tubular cylinder 20 is removed from lock body 14, as shown in FIG. 1, motion limiter plate 18 can be removed from its position on rekeyable tubular cylinder 20, and second core piece 36 can be turned from the operational position, shown in FIG. 6, to the rekeying position, shown in FIG. 7. The operational position, as opposed to the rekeying position, discussed below, indicates that replaceable pin openings 32 in hub portion 64 are coaxially aligned with locking pin openings 54 in first core piece 30 (see FIGS. 10 and 11).

Referring now to FIG. 5, a spring-driven rekeying latch 44 is contained within an opening 45 in intermediate shaft portion 70. A rekeying latch opening 46 is defined in first core piece 30. Additionally, a rekeying latch disengagement opening 47 is defined in outer sleeve 62 to be coaxially aligned with rekeying latch opening 46 when rekeyable tubular cylinder 20 is assembled. When rekeyable tubular cylinder 20 is in operation mode and motion limiter 18 is in place engaging motion limiter index pin 19 and lock release engaging portion 38, second core piece 36 can not be rotated so that rekeying latch 44 fits within rekeying latch opening 46. When motion limiter 18 is removed from rekeyable tubular cylinder 20, second core piece 36 can be rotated by a key 80 with appropriately configured pin engaging flats 84 to the position where rekeying latch 44 engages rekeying latch opening 46 and binds first core piece 30 and second core piece 36 together rotationally and longitudinally. In this rekeying position, key index tab 86 would align with index notch 76, permitting key 80 to be removed to facilitate rekeying of the rekeyable tubular cylinder 20. This is the rekeying position referred to above.

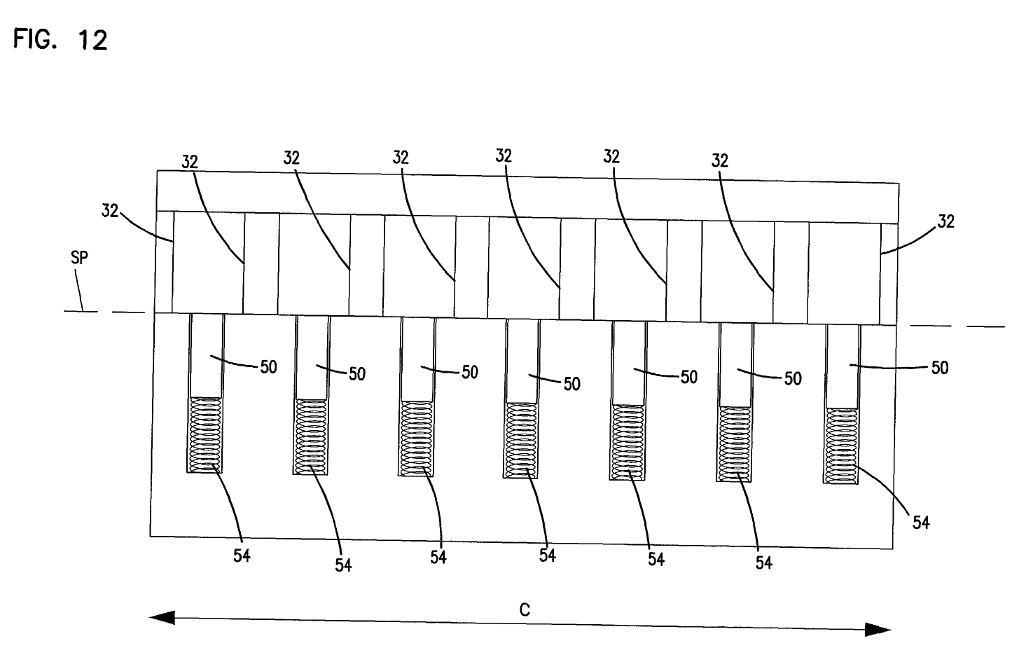

While tubular cylinder core 20 is in the rekeying position, the locking pin openings 54 and replaceable pin openings 32 are not axially aligned (see FIG. 12). In the rekeying position, locking pins 50 are fully contained within locking pin openings 54. Locking pin springs 52 are pressing locking pins 50 against the rear face 56 of cylinder portion 34 and rear face 56 prevents the pins protruding from locking pin openings 54 beyond front end face 66 of first core piece 30. The engagement of rekeying latch 44 in rekeying latch opening 46 prevent the force of locking pin springs 52, acting on locking pins 50, from dislodging second core piece 36 from first core piece 30,

Outer sleeve 62 is held in place over core pieces 30 and 36 by a setscrew 42, threadably mounted to first core piece 30 in threaded opening 41 and extending through an opening 43 in outer sleeve 62. When second core piece 36 has been rotated to the rekeying position and rekeying latch 44 has engaged rekeying latch opening 46, setscrew 42 can be removed from threaded opening 41, and outer sleeve 62 can be removed from rekeyable tubular cylinder 20. With outer sleeve 62 removed, replaceable pins 48 can accessed for removal and replacement.

With reference to the above described structure and to FIGS. 10 through 12, the process of rekeying a padlock in accordance with the present invention will be described. Beginning with a closed and locked padlock 10 as shown in FIG. 2, with tubular cylinder core 20 in the operational position, locking pins 50 and replaceable pins 48 are oriented as shown in FIG. 10, with the locking pins crossing the shear plane defined by faces 56 and 66, preventing the second core piece 36 from rotating within first core piece 30 and opening the lock. A key 80 is inserted into annular keyway 60 with index tab 86 passes through index notch 74, moving locking pins 50 and replaceable pins 48 to the orientation shown in FIG. 11 with the ends of locking pins 50 and replaceable pins 48 being aligned with the shear plane, and rotated. This rotation rotates second core piece 36 within first core piece 30, actuating lock release 15 and allowing locking 11 to slide inward, releasing shackle 12 so that spring 13 pushes the lock open, as shown in FIG. 3. A narrow tool is then inserted into opening 23 of lock body 14 to actuate cylinder release mechanism 22, permitting rekeyable tubular cylinder 20 to be removed from lock body 14, along with motion limiter plate 18. Motion limiter plate 18 is removed from tubular cylinder core 20. Key 80 is then turned so that index tab 86 is aligned with index notch 76, placing tubular cylinder core 20 in the rekeying position. Rekeying latch 44 will then snap within latch opening 46 and key 80 is removed from annular keyway 60. With latch 44 snapped within opening 46, relative axial and rotational movement is prevented between first core piece 30 and second core piece 36. Thus, latch 44 locks the core in the rekeying position of FIGS. 7 and 12.

Once core 20 is locked in the rekeying position, set screw 42 is removed from opening 41 in first core piece 30 and from opening 43 in outer sleeve 62. Outer sleeve 62 is then be removed from first core piece 30 and second core piece 36, exposing replaceable pins 48 so these pins can be removed. FIG. 12 shows first core piece 30 and second core piece 36 in the rekeying position, so that locking pins 50 are held inside locking pin openings 54 by face 56 of second core piece 36, and replaceable pins 48 have been removed. To affect a rekeying, current replaceable pins 48 would be removed and a new set of replaceable pins 148 corresponding to the pin engaging flats 184 of a new key 180 inserted into replaceable pin openings 32. Rekeyable tubular cylinder 20 would then be ready for reassembly and installation in lock body 14 for use with new key 180.

To reassemble the rekeyable lock cylinder for usage with a new key 180, the core pieces 30 and 36 are inserted into the opening 40 on outer sleeve 62 and oriented so that threaded opening 41 and opening 43 are coaxially aligned. Setscrew 42 is inserted through opening 43 in outer sleeve 62 to engage threaded opening 41 and threadably secured to first core piece 30, securing outer sleeve 62 about core pieces 30 and 36. New key 180 is inserted into annular keyway 60. An appropriately shaped tool is then inserted through openings 47 and 46 to engage rekeying latch 44 and compress rekeying latch 44 into rekeying latch opening 45. When rekeying latch 44 is sufficiently compressed, new key 180 is used to turn second core piece 36 toward the operational position, causing rekeying latch 44 to be captured within rekeying latch opening 45 by first core piece 30. The tool can then be removed from openings 47 and 46, and new key 180 used to rotate second core piece 36 until index tab 86 is aligned with index notch 74, indicating that rekeyable tubular cylinder 20 is now in the operational position.

Rekeyable tubular cylinder 20 can now be reinserted into tubular cylinder receiving opening 28 of lock body 14. Motion limiter plate 18 is placed on rear end face 68 of first core piece 30 and oriented so that motion limiter index pin 19 is engaged. Cylinder release mechanism 22 is then compressed so that rekeyable tubular cylinder 20 can be inserted into tubular cylinder receiving opening 28 and rotated so that index pin 24 protruding from the lower edge of rekeyable tubular cylinder 20 is aligned with index slot 26 in the sidewall base of tubular cylinder receiving opening 28. When index pin 24 and index slot 26 are aligned and rekeyable tubular cylinder 20 is fully inserted into lock body 14, lock release engaging portion 38 will engage lock release 15 and motion limiter plate 18 will be held in place engaging motion limiter index pin 19 by shoulder 72. Cylinder release mechanism 22 will snap within opening 23 to retain rekeyable tubular cylinder 20 within lock body 14. Rekeyable padlock 10 is now ready use with new key 180.

The embodiment described above refers to use of the rekeyable tubular cylinder in a padlock. Tubular cylinder core 20 can also be used in most applications where a tubular lock is employed and access can be had to the side of the locking mechanism so the user can actuate the cylinder release mechanism. A non-exclusive list of examples of possible applications includes vending machine doors, cabinet doors and machinery ignition switches.

The above specification, examples and data provide a complete description of the manufacture and use of the invention. Since many embodiments of the invention can be made without departing from the spirit and scope of the invention, the invention resides in the claims hereinafter appended.

What is claimed is as follows:

1. A rekeyable tubular lock cylinder comprising:
a core defining a reference axis, the core including:
(A) a first core piece defining plurality of locking pin openings that extend axially through at least a portion of the first core piece;
the first core piece also including a front end face through which the axial openings are defined and a rear end face; and
springs and locking pins mounted in the locking pin openings of the first core piece;
(B) a second core piece coaxially aligned with the first core piece, the second core piece including a cylinder portion, a hub portion and a lock release engaging portion:
(i) the cylinder portion including a front end face and rear end face, the rear end face of the cylinder portion facing the front end face of the first core piece, the cylinder portion defining replaceable pin openings that extend axially through the cylinder portion from the front end face to the rear end face;
(ii) the hub portion projecting axially outward from the front end of the cylinder portion and defining a key receiving notch;
(iii) the lock release engaging portion extending rearward from the cylinder portion axially through the first core piece; and
(iv) replaceable pins mounted in the replaceable pin openings of the second core piece; and
(C) an outer sleeve mounted over the first and second core pieces, the outer sleeve including inner and outer surfaces, and a sleeve end face defining a circular opening coaxially aligned with the hub portion of the second core piece, the sleeve end face and the hub portion cooperating to define an annular keyway, with the sleeve end face defining a first outer notch and a second outer notch circumferentially spaced about the circular opening;
(D) the hub portion of the second core piece being rotatable relative to the outer sleeve between a first position where the key receiving notch of the hub portion aligns with the first outer notch of the of the outer sleeve, and a second position where the key receiving notch of the hub portion aligns with the second outer notch; and
(E) the replaceable pin openings of the second core piece aligning with the locking pin openings of the first core piece when the hub portion of the second core piece is in the first position, and the replaceable pin openings of the second core piece not aligning with the locking pin openings of the first core piece when the hub is in the second position.

2. The tubular lock cylinder of claim 1, further comprising a removable fastener for preventing relative axial and rotational movement between the first core piece and the outer sleeve.

3. The tubular lock cylinder of claim 2, wherein the fastener is a setscrew that extends through an opening defined by the outer sleeve and is threaded within a radial opening defined by the first core piece.

4. The tubular lock cylinder of claim 1, wherein the second core piece includes an intermediate shaft interposed between the cylinder and the lock engaging portion, the intermediate shaft including a releasable mechanism for rotationally and axially fixing the second core piece with the first core piece when the key receiving notch of the hub portion of the second core piece is aligned with the second outer notch of the outer sleeve.

5. The tubular lock cylinder of claim 4, wherein the releasable mechanism is a spring loaded pin mounted on the intermediate shaft of the second core piece.

6. The tubular lock cylinder of claim 5, wherein the pin extends through a pin opening defined by the first core piece when the key receiving notch of the hub portion is aligned with the second outer notch of the outer sleeve.

7. The tubular lock cylinder of claim 6, wherein the outer sleeve defines an access opening that aligns with the pin opening of the first core piece to provide access for depressing the pin from the pin opening to allow relative rotation between the first and second core pieces.

8. The tubular lock cylinder of claim 1, wherein the tubular lock cylinder includes a releasable mechanism for fixing the tubular lock cylinder within a lock body.

9. The tubular lock cylinder of claim 8, wherein the releasable mechanism is a perpendicularly outward projecting, spring loaded pin mounted on the first core piece end adjacent to the lock release engaging portion of the second core piece, and projecting through a slot defined by the outer sleeve, beyond the outer surface of the outer sleeve.

10. The tubular lock cylinder of claim 1, wherein the first core piece includes an index pin projecting axially from the rear end face of the first core piece.

11. The tubular lock cylinder of claim 10, wherein a rotation limiter cooperates with the index pin projecting from the rear end face of the first core piece when the tubular lock cylinder is inserted into a lock body.

12. The tubular lock cylinder of claim 1, wherein the first and second notches in the annular keyway defined by the outer sleeve and the second core piece are equal in size and shape.

13. A method of rekeying a tubular lock cylinder comprising the steps of:
providing a tubular lock cylinder including a first core piece defining a plurality of locking pin openings that extend axially through at least a portion of the first core piece, a second core piece coaxially aligned with the first core piece, the second core piece defining replaceable pin openings which extend axially through the second core piece, replaceable pins inserted within the replaceable pin openings and an outer sleeve coaxially mounted over the first and second core pieces, with the second core piece and the outer sleeve cooperating to form an annular keyway;
inserting an annular key into the annular keyway defined by the second core piece and the outer sleeve with the first and second core pieces in a position such that the locking pin openings and the replaceable pin openings are axially aligned, rotating the key to a second position where the locking pin openings and the replaceable pin openings are not axially aligned, and removing the key;
while the locking pin openings and the replaceable pin openings are not aligned, removing the outer sleeve from the tubular lock cylinder, allowing access to the replaceable pins;
while the locking pin openings and the replaceable pin openings are not aligned and the outer sleeve is removed, replacing the replaceable pins to match a new circular key;
while the locking pin openings and the replaceable pin openings are not aligned and the outer sleeve has been removed, and after the replaceable pins have been replaced to match the new circular key, replacing the outer sleeve over the first and second core pieces; and
once the replaceable pins have been replaced to match the new circular key and the outer sleeve has been replaced, and with the locking pin openings and the replaceable pin openings not aligned, inserting the new circular key into the keyway and rotating the new circular key to the position where the locking pin holes in the first core piece and the replaceable pins in the second core piece are axially aligned.

14. A rekeyable padlock comprising:
a lock body defining a cavity for receiving a rekeyable tubular lock cylinder;
a shackle for engaging an object to be secured;
a mechanism, actuated by the rekeyable tubular lock cylinder, within the lock body for releasing and retaining the shackle;
the rekeyable tubular lock cylinder including a core, said core including:
(A) a first core piece defining plurality of locking pin openings that extend axially through at least a portion of the first core piece;
the first core piece also including a front end face through which the axial openings are defined and a rear end face; and
springs and locking pins mounted in the locking pin openings of the first core piece;
(B) a second core piece coaxially aligned with the first core piece, the second core piece including a cylinder portion, a hub portion and a lock release engaging portion:
(i) the cylinder portion including a front end face and rear end face, the rear end face of the cylinder portion facing the front end face of the first core piece, the cylinder portion defining replaceable pin openings that extend axially through the cylinder portion from the front end face to the rear end face;
(ii) the hub portion projecting axially outward from the front end of the cylinder portion and defining a key receiving notch;
(iii) the lock release engaging portion extending rearward from the cylinder portion axially through the first core piece; and
(iv) replaceable pins mounted in the replaceable pin openings of the second core piece; and
(C) an outer sleeve mounted over the first and second core pieces, the outer sleeve including inner and outer surfaces, and a sleeve end face defining a circular opening coaxially aligned with the hub portion of the second core piece, the sleeve end face and the hub portion cooperating to define an annular keyway, with the sleeve end face defining a first outer notch and a second outer notch circumferentially spaced about the circular opening;
(D) the hub portion of the second core piece being rotatable relative to the outer sleeve between a first position where the key receiving notch of the hub portion aligns with the first outer notch of the of the outer sleeve, and a second position where the key receiving notch of the hub portion aligns with the second outer notch; and
(E) the replaceable pin openings of the second core piece aligning with the locking pin openings of the first core piece when the hub portion of the second core piece is in the first position, and the replaceable pin openings of the second core piece not aligning with the locking pin openings of the first core piece when the hub is in the second position.

15. The rekeyable padlock of claim 14, further comprising a removable fastener for preventing relative axial and rotational movement between the first core piece and the outer sleeve.

16. The rekeyable padlock of claim 15, wherein the fastener is a setscrew that extends through an opening defined by the outer sleeve and is threaded within a radial opening defined by the first core piece.

17. The rekeyable padlock of claim 14, wherein the second core piece includes an intermediate shaft interposed between the cylinder and the lock engaging portion, the intermediate shaft including a releasable mechanism for rotationally and axially fixing the second core piece with the first core piece when the key receiving notch of the hub portion of the second core piece is aligned with the second outer notch of the outer sleeve.

18. The rekeyable padlock of claim 17, wherein the releasable mechanism is a spring loaded pin mounted on the intermediate shaft of the second core piece.

19. The rekeyable padlock of claim 18, wherein the pin extends through a pin opening defined by the first core piece when the key receiving notch of the hub portion is aligned with the second outer notch of the outer sleeve.

20. The rekeyable padlock of claim 19, wherein the outer sleeve defines an access opening that aligns with the pin opening of the first core piece to provide access for depressing the pin from the pin opening to allow relative rotation between the first and second core pieces.

21. The rekeyable padlock of claim 14, wherein the tubular lock cylinder includes a releasable mechanism for fixing the tubular lock cylinder within a lock body.

22. The rekeyable padlock of claim 21, wherein the releasable mechanism is a perpendicularly outward projecting, spring loaded pin mounted on the first core piece end adjacent to the lock release engaging portion of the second core piece, and projecting through a slot defined by the outer sleeve, beyond the outer surface of the outer sleeve.

23. The rekeyable padlock of claim 14, wherein the first core piece includes an index pin projecting axially from the rear end face of the first core piece.

24. The rekeyable padlock of claim 23, wherein a rotation limiter cooperates with the index pin projecting from the rear end face of the first core piece when the tubular lock cylinder is inserted into a lock body.

25. The rekeyable padlock of claim 14, wherein the first and second notches in the annular keyway defined by the outer sleeve and the second core piece are equal in size and shape.

26. A rekeyable tubular lock cylinder comprising:
a first core piece defining a plurality of locking pin openings circumferentially spaced about a reference axis of the first core piece;
a plurality of springs and locking pins mounted in the locking pin openings;
a second core piece defining a plurality of replacement pin openings, the second core piece being rotatable relative to the first core piece between a first position where the replaceable pin openings align with the locking pin openings and a second position where the replaceable pin openings do not align with the locking pin openings; and
a releasable fastener for preventing relative axial and rotational movement between the first and second core pieces when the second core piece is moved to the second position.
